(19) United States
(12) Patent Application Publication
(10) Pub. No.: US 2013/0268372 A1
(43) Pub. Date: Oct. 10, 2013

(54) SYSTEM, METHOD, AND COMPUTER-READABLE STORAGE MEDIUM FOR CONSOLIDATING AND PERSONALIZING THE DELIVERY OF MARKETING COMMUNICATIONS

(71) Applicant: Reza Jalili, Sandy, UT (US)

(72) Inventor: Reza Jalili, Sandy, UT (US)

(73) Assignee: STOR NETWORKS, INC., Sandy, UT (US)

(21) Appl. No.: 13/855,712

(22) Filed: Apr. 3, 2013

Related U.S. Application Data
(60) Provisional application No. 61/620,427, filed on Apr. 4, 2012.
(60) Provisional application No. 61/693,282, filed on Aug. 25, 2012.

(51) Int. Cl. G06Q 30/02

(52) U.S. Cl. CPC G06Q 30/0277
USPC 705/14.66

(57) ABSTRACT

A system, method, and computer-readable storage medium for enabling the aggregation of electronic marketing communication data distributed to consumers via an electronic network, such as the Internet, thereby providing one or more convenient mechanisms by which an individual may access and manage marketing communication data from one or more marketing entities distributed via one or more communication channels, including an improved inbox designed for marketing communications and multi-channel communications.

### CROSS-REFERENCE

This application claims the benefit of U.S. provisional application No. 61/620,427, filed Apr. 4, 2012 and U.S. provisional application No. 61/693,282 filed Aug. 25, 2012. Each of these applications is incorporated by reference herein, in their entireties, for all purposes.

### FIELD

Example embodiments of the present invention generally pertain to electronic marketing communications distributed via an electronic network. More particularly, example embodiments of the present invention pertain to aggregating and distributing electronic marketing communications communicated via an electronic network.

### BACKGROUND

Electronic marketing has become one of the primary methods of soliciting business from consumers. Electronic marketing includes various advertising approaches, such as electronic ads, direct emails to consumer, social networking posts and applications, text messages, and the like. Unlike other marketing methods, consumers often have control of how they receive electronic marketing materials. For example, a consumer may subscribe or unsubscribe from a business's email marketing list, may select the type of promotional emails to receive, and may connect to or disconnect from a business's social networking outlet (e.g., by “Liking” or “Unliking” the business's Facebook page).

While such practices provide consumers with a degree of control over the marketing they receive, electronic marketing has become so ubiquitous that it inundates consumers. For example, a consumer may receive marketing emails from one company, Facebook posts from another company, Twitter posts from another business, text messages from another, and so on. All these channels can overwhelm consumers and may reduce the effectiveness of marketing efforts. To cause further confusion, if a consumer uses more than one of these channels (e.g., email and a social network), the consumer may receive multiple marketing communications from the same business via each channel. For example, a consumer may subscribe to a business's emailing list, “Like” it on Facebook, “Follow” it on Twitter, and subscribe to its text message coupons. This can lead to consumers feeling saturated with marketing and, as a result, the marketing may lose its effectiveness as the consumer begins to ignore one or more of the marketing methods. Due to the sheer quantity of electronic marketing communications consumers receive from numerous sources, consumers miss deals and important marketing announcements. For example, a company may post a timed deal to Facebook, but a consumer may miss out because he did not check the site in time. Email inboxes are overly clogged with emails because consumers do not have the time or patience to organize, review, and use all the various promotions received. After a saturation point, a consumer is likely to delete many marketing emails rather than spend the time reviewing them all, and this results in a missed opportunity for both marketers and the consumer.

Current email services and applications do not handle marketing communications well because they were not designed specifically for commercial communications. The design and functionality of email inboxes have largely remained unchanged from the origination of email. As such, consumers lack a mechanism that handles marketing communications in a convenient and useful manner.

What is needed is a mechanism designed to improve the delivery of electronic marketing communications distributed via multiple communication channels. Furthermore, what is needed is a medium that enables consumers to customize how they receive electronic marketing communications and enable consumers to organize such communications. What is also needed is a medium designed to a provide enhanced inbox-like functionality for the receipt of marketing communications that improves the manner in which marketing communications, including commercial communications, are handled and presented.

### SUMMARY

Example embodiments of the present invention address the aforementioned needs by providing a system, method, and computer-readable storage medium for enabling the aggregation of electronic marketing communication data distributed to consumers via an electronic network, such as the Internet. Furthermore, example embodiments of the present invention provide one or more convenient mechanisms by which an individual may access and manage marketing communication data from one or more marketing entities distributed via one or more communication channels. Moreover, examples embodiments of the present invention provide an improved inbox designed for marketing communications and multi-channel communications.

### BRIEF DESCRIPTION OF THE DRAWINGS

In order to describe the manner in which the above-recited and other advantages and features example embodiments of the invention may be obtained, a more particular description of example embodiments of the invention briefly described above will be rendered by reference to specific example embodiments thereof that are illustrated in the appended drawings. Understanding that these drawings depict only typical example embodiments of the invention and are not therefore to be considered limiting of its scope, the invention will be described and explained with additional specificity and detail through the use of the accompanying drawings in which:

FIG. 1 depicts a component architecture of a marketing network including a marketing communication management system according to an example embodiment;

FIG. 2 depicts an architecture overview of a marketing communication management system according to an example embodiment;

FIG. 3 depicts a flowchart of various steps in a method of generating a user profile for a marketing communication management system according to an example embodiment;

FIG. 4 depicts a flowchart of various steps in a method for associating a marketing entity with a user profile via a marketing communication link according to an example embodiment;

FIG. 5 depicts a flowchart of various steps in a method for managing the receipt of a social network post via a marketing communication management system according to an example embodiment;

FIG. 6 depicts a flowchart of various steps in a method for managing the receipt of an email or text message via a marketing communication management system according to an example embodiment;

FIG. 7 depicts a flowchart of various steps in a method for managing the receipt of an email via a marketing communication management system email extension according to an example embodiment; and

FIG. 8 depicts a flowchart of various steps in a method for delivering a marketing communication with a response link via a marketing communication management system according to an example embodiment.

### DESCRIPTION

Various example embodiments of the invention are discussed in detail below. While specific implementations are discussed, it should be understood that this is done for illustration purposes only. A person with ordinary skill in the relevant art will recognize that other components and configurations may be used without departing from the spirit and scope of the present invention.

Example embodiments of the present invention is described herein mainly in terms of an individual accessing the Internet, such as via a personal computer (e.g., a desktop computer, a laptop computer, a tablet computer, etc.), a mobile phone, or a multipurpose mobile device (e.g., a smartphone, a personal electronic assistant, etc.). This is not to be construed as limiting as the present invention may be applicable to any electronic network accessible to a user via a network-appropriate device. For example, example embodiments of the present invention may be applied to broadcast networks (e.g., cable, satellite, etc.), mobile networks, interactive television systems, kiosk systems, and any technologies that enable the electronic display of advertisements.

### Marketing Network

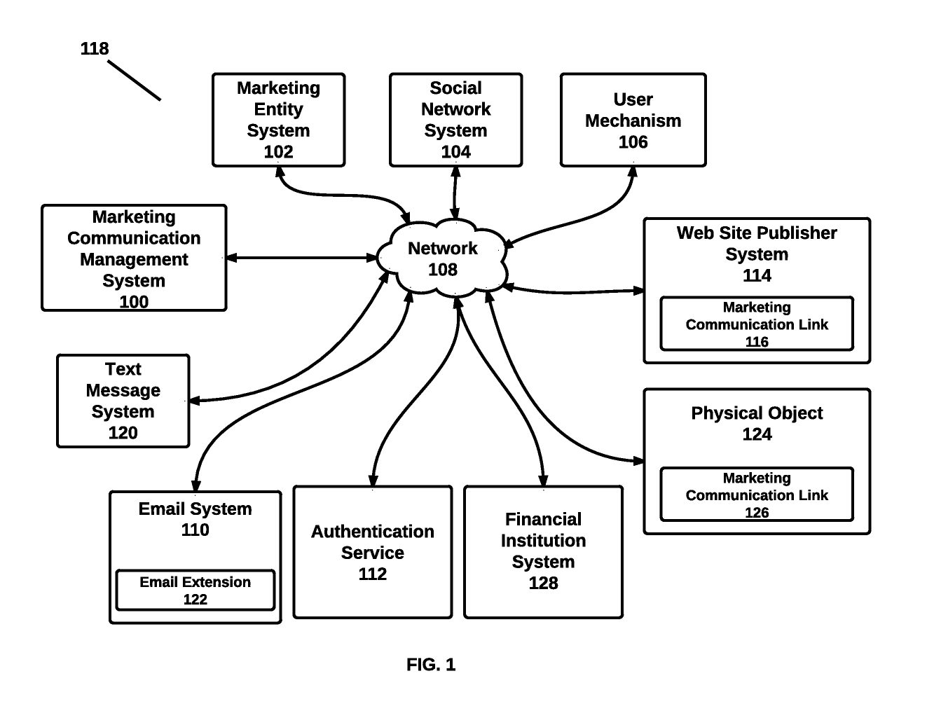

FIG. 1 depicts a component architecture of a marketing network, marketing network 118, including a marketing communication management system (MCMS) according to an example embodiment. The components of marketing network 118 may interact with one another via electronic network 108, which may be an applicable electronic network, such as the Internet or a mobile network. The components are herein referenced as “systems,” “mechanisms,” etc. This is not to be construed as limiting and it is to be understood that each component may include the necessary hardware, firmware, and/or software to enable the processing, storing, communicating and/or receiving of data. For example, a component may include one or more computer processors, computer servers, data stores, electronic components, storage mediums, memory, etc. Although only a single instance of each component is depicted, this is for illustrative purposes only and is not to be construed as limiting, as marketing network 118 may include multiple instances of each component. For example, marketing network 118 may include multiple MCMSes 100, marketing entity systems 102, social network systems 104, user mechanisms 106, electronic networks 108, email systems 110, authentication systems 112, Web site publisher systems 114, text message systems 120, and/or financial institution systems 128. Furthermore, although each component is depicted and described herein as separate, this is not to be construed as limiting, and components may be combined per implementation. For example, MCMS 100 and marketing entity system 102 may be combined into one component and/or be maintained by the same entity or affiliated entities.

MCMS 100 may be a system that enables the management, storage, and control of marketing communications distributed by one or more marketing entities. A marketing communication, as used herein, is meant to include any electronic communication distributed by a marketing entity. For example, a marketing communication may be an email, a social network post (e.g., a post to Facebook, Twitter, Pinterest, Google+, etc.) a text message, an electronic advertisement, electronic marketing data associated with a physical object, a product package, a video, or any other electronic communication. A marketing communication may be designed to entice a recipient to purchase and/or use a good or service (herein referred to collectively as a “product”) associated with the marketing entity. A marketing communication may be another communication from a marketing entity, such as a communication regarding a product order, a product update, warranty information, etc.

A marketing entity may be an organization or individual that distributes marketing communications. For example, a marketing entity may be a manufacturer, a merchant (e.g., a retailer, a reseller, a vendor, etc.), a marketing service, etc. Marketing entity system 102 may enable the distribution of marketing communications and may maintain electronic marketing content. Marketing entity system 102 may be maintained by a marketing entity or by a service employed by a marketing entity and MCMS 100 may interact with several, disparate marketing entity systems 102. In one embodiment, marketing entity system 102 may include or interact with a purchase system for an associated merchant or manufacturer and, thereby, maintain or access transactional data (e.g., purchase history data) associated with one or more consumers. Marketing entity system 102 may include or interact with a loyalty system for an associated merchant or manufacturer and, thereby, maintain or access transactional data associated with consumer loyalty accounts (e.g., shopper card accounts, reward accounts, etc.).

Financial institution system 128 may be any system that pertains to the use of financial accounts, such as a bank, a credit card issuer, a payment processor, an online payment service, a mobile payment service, etc. Financial institution system 128 may maintain transactional data associated with the use of a financial account. Financial institution system 128 may maintain data associated with reward programs, such as frequent flyer miles, reward points, etc.

Marketing network 118 may include one or more social network systems 104, such as Facebook, Twitter, Google+, an online forum or message board, etc. Marketing network 118 may include text message system 120, which may be managed by a mobile phone service provider, an independent text messaging service, etc. For example, text message system 120 may be managed by a mobile phone service provider, such as Verizon, T-Mobile, AT&T, etc. Marketing network 118 may include email system 110, which may be managed by an email service providing entity, such as Google, Yahoo, Microsoft, or the like. For example, email system 110 may enable a service such as Gmail, Yahoo Mail, Microsoft Hotmail, Microsoft Exchange, etc.

In one example embodiment, marketing network 118 may include authentication service 112, which may authenticate users when they access MCMS 100 and/or other marketing network 118 components. Alternatively, MCMS 100 and/or another marketing network 118 component may handle authentication. In one example embodiment, social network system 104 or email system 110 may authenticate users instead of, or in addition to, MCMS 100 or authentication service 112. MCMS 100 may interface with Facebook, Google, and/or other Web services such that, for the majority of users for the majority of the time, no prompting of user credentials is necessary when the user is already logged into one of those services using user mechanism 106. For example, a user may be able to access MCMS 100 by logging into his Facebook or Google account.

Web site publisher system 114 may be any system that enables the distribution of electronic content via a Web site. For example, Web site publisher system 114 may include a Web server and may enable a user to view a Web page via user mechanism 106. For particular functions, Web site publisher system 114 may employ marketing communication link (MCL) 116 to interact with marketing network 118.

Marketing network 118 may interact with physical object 124, which may be, for example, a billboard, a poster, a product, a magazine ad, etc. Physical object 124 may be enabled to interact with marketing network 118 via MCL 126, as described in detail below.

A user may interact with one or more components of marketing network 118 via user mechanism 106. User mechanism 106 may include hardware, software, and/or firmware configured to enable the viewing and the inputting of information by the user. For example, a user may access MCMS 100 by loading a Web page on his personal computer via a web browser, such as Microsoft Internet Explorer or Mozilla Firefox, or through his smartphone via its browsing application or via an MCMS application. Additionally, user mechanism 106 may be other properly equipped devices, such as a television, kiosk, or other presentation system. Furthermore, MCMS 100 may be accessible via various example embodiments of user mechanism 106 and a user may employ any combination of these. For example, a user may access marketing communications via his mobile phone at one point and later access marketing communications via his television.

### Marketing Communication Management System (MCMS)

MCMS 100 may enable a user to access, from one virtual location, marketing communications distributed by one or more marketing entities via various communication channels. A communication channel may be any medium by which a marketing entity may distribute marketing material to an audience. A communication channel may be an email communication channel, a social network communication channel, text message communication channel, electronic advertising, physical advertising, etc. For example, a user may access MCMS 100 to view a marketing entity's emails, social network posts, and text messages instead of accessing the emails from email system 110, the social network post via social network system 104, and the text messages via a text messaging application. As a user may associate more than one marketing entity with his user profile, he may access such various marketing communications from several marketing entities, thereby enabling the user to have marketing communications from various sources accessible via one access point. MCMS 100 may enable the integration and aggregation of all of a marketing entity's communication channels without incremental effort on the part of the marketing entity. As MCMS 100 may function as a platform for the aggregation of existing communication channels, it may serve as a convenient and accessible medium to enhance the distribution and presentation of marketing communications via these existing communication channels.

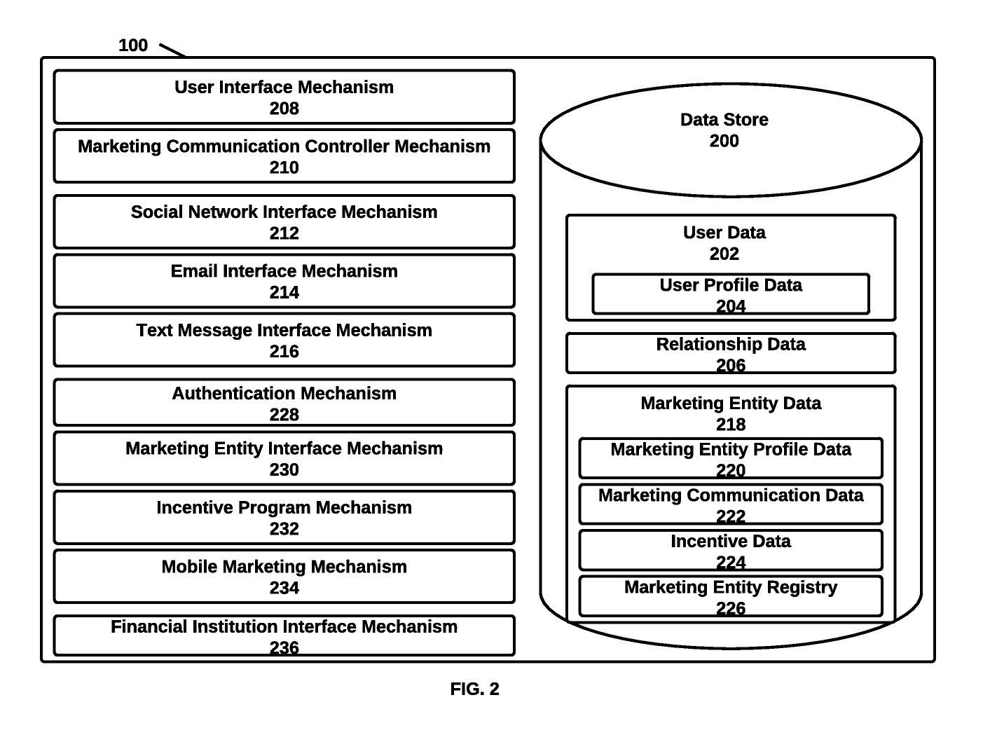

FIG. 2 depicts an architecture overview of an exemplary MCMS according to an example embodiment. MCMS 100 may include one or more components to enable a user to manage marketing communications. Data store 200 may maintain user data 202 for each user. A user identifier may be used to reference the user data 202 of a particular user. For example, a user identifier may be a user's email address, a social network user identifier, a username, an identification code, a telephone number, other alphanumeric data, etc. A user identifier may reference a user profile. User profile data 204 may be user data 202 specific to a user, such as credential information (e.g., username and password, social network credentials, etc.), personal information, contact information (email address, phone number, etc.), demographic data (e.g., sex, age, etc.), financial account data, user preferences (e.g., marketing communication preferences, privacy preferences, etc.), loyalty account data, etc. Financial account data may include, for example, checking or savings account numbers, credit card information (e.g., credit card numbers, expiration dates, security codes, etc.), online payment account information (e.g., PayPal, Square, etc.), etc. Loyalty account data may include information associated with one or more loyalty or reward programs, such as loyalty card numbers (e.g., shopper card numbers, etc.), reward program numbers (e.g., for frequent flyer or reward point accounts, etc.), etc. In one example embodiment, a user profile may be generated, accessed, and/or modified via a third party service, such as social network 104 and/or email system 110.

Data store 200 may maintain marketing entity data 218 for each marketing entity whose data has been obtained by MCMS 100. Marketing entity data 218 may include a marketing entity identifier that may be used to reference a particular marketing entity profile and may be any data employable by MCMS 100 to reference the marketing entity. For example, a marketing entity identifier may be a name of an associated marketing entity, a URL, a tracking cookie, etc., an email address, a Web site address, social network account data (e.g., Facebook profile link, Twitter profile link, etc.), an encryption key, other alphanumeric data, etc. Marketing entity data 218 may include marketing entity profile data 220 which may include marketing entity data 220 specific to a particular marketing entity, such as credential information (e.g., for marketing representatives), descriptive data, contact information (e.g., email account information, mailing address, phone numbers, etc.), financial account data, marketing preferences, one or more rules pertaining to response link management, Web site information, social network account data, etc. In one example embodiment, a marketing entity profile data 220 may include one or more marketing entity identifiers.

Marketing entity data 218 may include a marketing entity registry 226 which may index marketing entities. Marketing entity registry 226 may include participating marketing entities and non-participating marketing entities. Marketing entities may be added in various fashions. For example, a marketing entity may contact the MCMS service provider and request to be added or the MCMS service provider can solicit registrations from marketing entities (in one scenario, per user request). Additionally, as described below, a marketing entity may be added per data accessed from a third party account, via an MCL, and/or per email address or phone number registration. For example, MCMS 100 may receive marketing entity data 218 by accessing social network system 104 and/or email system 110, from an MCL, from public sources, etc.

Marketing entity data 218 may include marketing communication data 222, which may include information associated with marketing communications distributed by a marketing entity. For example, marketing communication data 222 may include information regarding a marketing entity's email distribution list (e.g., to enable collection of a marketing entity's promotional emails), social network account data (e.g., to enable collection of a marketing entity's social network posts), loyalty programs (e.g., frequent shopper data), etc. Marketing entity data 218 may include incentive data 224, which may include information regarding incentives offered by a marketing entity. Incentive data 224 may include, for example, information regarding discounts, coupons data (e.g., promotion codes, printable coupons, etc.), etc. In one scenario, MCMS 100 may enable user use and/or redemption of a marketing entity's incentives.

In one scenario, marketing entity data 218 may include meta-tags for the relevant marketing entity and the meta-tags may describe features and modules, such as location, a social network pages, address, latest marketing communication, incentive data, etc.

Data store 200 may include relationship data 206, which may include data pertaining to how particular users and marketing entities are related to other users and marketing entities. Relationship data 206 may indicate connections between one or more user profiles and/or between one or more user profiles and one or more marketing entity profiles. For example, relationship data 206 may indicate which users an individual has listed as friends or which users have signed up to receive a marketing entity's marketing communications. Additionally, relationship data 206 may indicate associations between marketing entities. For example, one marketing entity may be parent entity with one or more child marketing entities or two or more marketing entities may be indicated as affiliates or partners.

User interface mechanism 208 may enable a user create a user profile, establish one or more preferences, add, edit, and/or remove user data 202, provide feedback regarding marketing communications and/or marketing entities, share marketing communications with other users or external parties, comment on marketing communications, organize marketing communications, communicate with other users or marketing entities, etc. For example, user interface mechanism 208 may enable a user to add or delete a marketing entity from his user profile, customize the types of marketing communication he wishes to receive from a particular marketing entity (e.g., emails, social network posts, etc.), customize the manner and/or timing in which marketing communications are delivered, specify how marketing communications should be organized, etc. In general, user interface mechanism 208 may enable a user to perform any user-driven procedure described herein.

MCMS 100 may include marketing communication controller mechanism 210 which may enable MCMS 100 to interact with other entities via electronic network 108. Marketing communication controller mechanism 210 may manage received marketing communications, enable the delivery of marketing communications to the appropriate users, enable the communication of user feedback to a marketing entity, screen and/or filter received marketing communications, organize marketing communications, enable the receipt of marketing entity data 218, enable the receipt of user data 202, etc.

MCMS 100 may include social network interface mechanism 212, thereby enabling MCMS 100 interaction with social network system 104, including the receipt and distribution of social network communications. Social network interface mechanism 212 may include an application programming interface (API) that enables it to receive data from social network system 104. Social network interface mechanism 212 may enable MCMS 100 to access a marketing entity's social network posts, obtain data from user and/or marketing entity social network accounts, etc., as described below. One or more elements of user data 202 and/or relationship data 206, may be stored in association with a user's social network system account in addition to, or instead of, being associated maintained by data store 200.

Email interface mechanism 214 may enable MCMS 100 to interact with email system 110, including the receipt and distribution of email communications. Email interface mechanism 214 may receive emailed communications sent to an email address associated with MCMS 100, such as a general MCMS email address or an MCMS email address associated with an individual user. Email interface mechanism 214 may include an API that enables it to access data from user email accounts, such as email data, contact data, etc., as described below. In one example embodiment, email interface mechanism 214 may enable MCMS 100 to access email sent to or from an email service (e.g., Gmail, Yahoo Mail, Hotmail, etc.) thereby allowing MCMS to add additional functionality to the email service. For example, email interface 214 may enable MCMS 100 to serve as an enhancement for a user's email Web service account. In one scenario, email interface mechanism 214 may enable MCMS 100 to interact with a client-server email application, such as Microsoft Exchange.

Text messaging interface mechanism 216 may enable MCMS 100 to interact with text message system 120, including the receipt and distribution of text message communications. Text message interface mechanism 120 may receive texted and/or emailed communications sent to a phone number associated with MCMS 100, such as a general MCMS phone number or to an MCMS phone number associated with an individual user.

Authentication mechanism 228 may enable MCMS 100 to authenticate users and/or marketing entities. For example, authentication mechanism 228 may analyze credentials provided by a user or marketing entity in order to allow the user or marketing entity to access the appropriate account. An authenticated user may access one or more elements of his user profile data 204, configure a preference, etc. An authenticated marketing entity may refine its association with MCMS 100, distribute a marketing communication, analyze user data 202, review marketing preferences and/or incentive usage, etc. MCMS 100 may restrict marketing entity access to certain aspects of user data 202 to ensure user privacy. In one example embodiment, a marketing entity may only access anonymous user data or data that a user has explicitly granted permission for the marketing entity to access.

Marketing entity interface mechanism 230 may enable a marketing entity to analyze data obtained by MCMS 100, analyze the receipt of marketing communications, target marketing communications to MCMS 100 users, obtain, review, and/or respond to user feedback, communicate with users, configure an incentive program, etc. In general, marketing entity interface mechanism 230 may enable a marketing entity to perform any marketing entity-related procedure described herein. Marketing entity interface 230 may enable MCMS 100 to receive transactional data (e.g., purchase data) associated with marketing entities, such as merchants or manufacturers, including data associated with consumer loyalty accounts.

MCMS 100 may include incentive program mechanism 232 which may manage the distribution, accounting, tracking, and compliance of incentive programs enabled by MCMS 100. MCMS 100 may include financial institution interface mechanism 236, which may enable MCMS 100 to interact with financial institution system 128, including the receipt of transactional data associated with one or more financial accounts. Financial institution interface mechanism 236 may include an API that enables it to access transactional data, as described below.

Mobile marketing mechanism 234 may manage the distribution of mobile marketing communications, manage the location-tracking a user's via user mechanism 106 (either by mobile marketing mechanism 234 or a third party service), manage the aggregation of localized mobile marketing communications, or any other mobile-related procedure described herein.

### MCMS User Profile

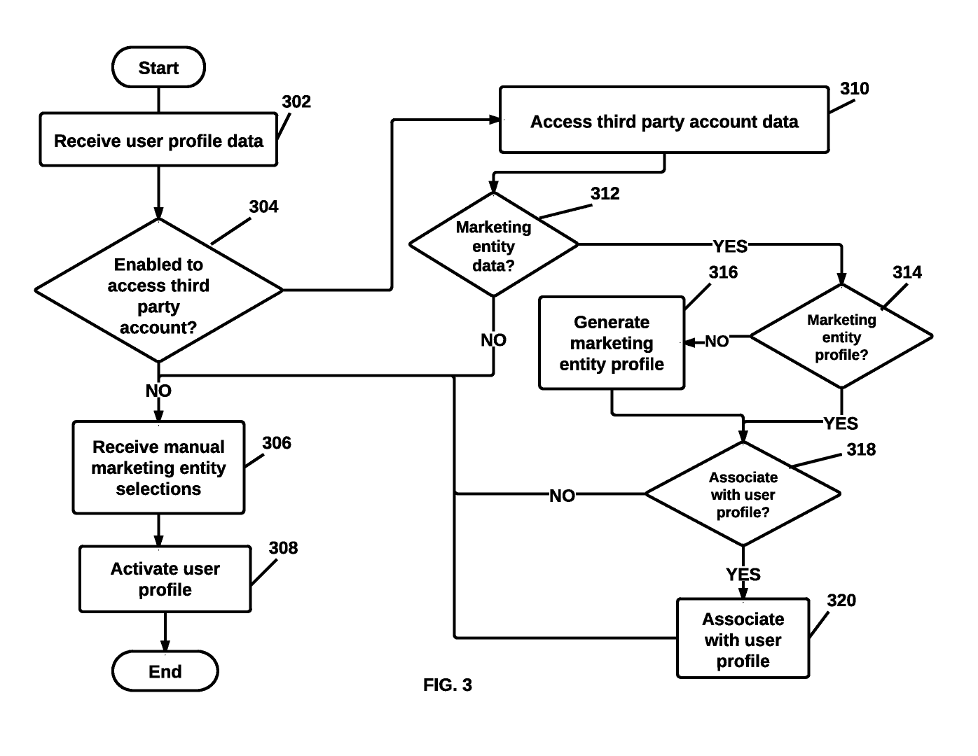

FIG. 3 depicts a flowchart of various steps in a method of generating a user profile according to an example embodiment. A user may initiate user profile creation via an MCMS Web site, via a partner Web site, via a social network site (e.g., via a social network application, etc.), via an email service (e.g., by installing an email plug-in, etc.), etc. A user may be instructed to provide user profile data 204, which may be provided by entering the data into input fields. For example, a user may provide credential information, social network account data, email account data, and other registration information and may specify one or more user preferences. A user preference may establish how a user wishes to receive marketing communications via MCMS 100, such as the format, the timing, how marketing communications should be organized, etc. A user may also establish whether MCMS 100 have access to any third party accounts a user has registered, such as social networking accounts, email accounts, etc. By enabling MCMS 100 to access data held by the third party, such as social network system 104 or email system 110, the user may enhance the generation of a user profile.

Once MCMS 100 has received user profile data (step 302), MCMS 100 may determine whether the user has enabled it to access to one or more third-party accounts (step 304). If MCMS 100 is not enabled to access a third party account, a user may be prompted to manually select one or more marketing entities listed in marketing entity registry 226 and MCMS 100 may receive these selections (step 306). MCMS 100 may then activate the user profile (step 308).

If the user has enabled MCMS 100 to access a third party account, it may access the third party account data maintained by the appropriate system (e.g., social network system 104, email system 110, user mechanism 106, etc.) (step 310) and determine if the third party account data includes data indicative of one or more marketing entities (step 312). This may be accomplished through one or more avenues. MCMS 100 may access the third party site via an API and the API may enable MCMS 100 to access and analyze the third party account data. If the third party system is social network system 104, MCMS 100 may determine which items a user has “Liked,” “Followed,” “Plused,” etc. and may determine whether these items include data indicative of marketing entities.

If the third party system is email system 110, MCMS 100 may analyze email account data to determine whether any stored emails and/or contacts include data indicative of a marketing entity. For example, MCMS 100 may analyze “From” addresses to determine which entity has sent an email, such as by referencing such data against marketing entity data 218. Header information [DomainKeys Identified mail (DKIM), etc.] may be used to authenticate and/or verify that the identified entity is in fact the legitimate sender. In one example embodiment, if a marketing entity has been previously registered with MCMS 100, the marketing entity may include an MCMS code in its email header and/or may implement an interaction medium (e.g., an API, etc.) that enables MCMS 100 to determine whether the marketing entity sent an email by sending the MCMS code to the marketing entity to verify that the email actually was sent by the marketing entity. The verification of the sending entity by MCMS 100 may serve as an opportunity for MCMS 100 to obtain more information from the sender (in one scenario, in real-time) to add to the associated email. For example, MCMS 100 may ascertain the number of users that have opened the email, the number of users who have responded to an offer included in the email, etc. The information obtained and/or a timestamp may be used to enhance analytics enabled by MCMS 100.

If the third party system is user mechanism 106, MCMS 100 may analyze data stored via user mechanism 106. For example, if user mechanism 106 includes a Web browser, MCMS 100 may analyze bookmarks, cookies, Web history, etc. As another example, if user mechanism 106 is a mobile device, such as a smartphone, MCMS 100 may access applications, stored user data, text message data, etc. If MCMS 100 determines that marketing entity data is not present in the third-party account, it may prompt a user to select manually one or more marketing entities included in marketing entity registry 226 (step 306).

If MCMS 100 determines that marketing entity data is present, it may determine whether it has a marketing entity profile for the associated marketing entity (step 314). If MCMS 100 does not, it may use the obtained marketing entity data to generate a marketing entity profile (step 316). Once MCMS 100 has determined the presence of a corresponding marketing and/or generated a marketing profile, it may determine whether to associate the marketing entity with the user profile (step 318). The user may be presented with a display listing the marketing entities MCMS 100 has located via the accessed the third party account and may prompt the user to select which marketing entities to associate with his user profile. Furthermore, MCMS 100 may determine itself whether to associate a marketing entity with a user profile. For example, if a marketing entity profile was generated based upon the user's third party account data (e.g., step 316), MCMS 100 may not wish to associate the marketing entity with a user profile until it has secured participation from the marketing entity and/or has validated the legitimacy of the marketing entity.

If no marketing entity is to be associated with the user profile based upon the accessed third party account data, MCMS 100 may prompt the user to select manually one or more marketing entities from marketing entity registry 226 (step 306). If it has been determined that a marketing entity determined by the accessed third party account data should be associated with the user profile, MCMS 100 may do so (step 320), and then prompted the user to select further marketing entities from those listed in marketing entity registry 226 (step 306). Once MCMS 100 has obtained all the necessary user profile data, marketing entity selections, etc., it may activate the user profile (step 308). The user may now employ MCMS 100 to receive marketing communications (e.g., emails, social network posts, text messages, etc.) from marketing entities associated with his user profile.

Once a user has created a user profile, he may repeat one or more of the previously described steps in order to update, enhance, or modify his user profile. For example, that did not allow MCMS 100 to access a third-party account initially may later enable it to do so in order to associate his user profile with more marketing entities.

As mentioned, MCMS 100 may create a marketing entity profile based upon data accessed from a third party account. Data obtained from an account held with social network system 104 and/or email system 110 may indicate a marketing entity. MCMS 100 may use this marketing entity data to create a new marketing entity profile. For example, the obtained marketing entity profile may include a name, a URL for the marketing entity's Web site, descriptive information, etc. and this data may be stored in association with the marketing entity profile. MCMS 100 may perform an automated process to retrieve further information, such as by crawling the Internet for further data, locating social network posts, obtaining electronic newsletter information (e.g., by subscribing), issuing an email or other electronic communication to the marketing entity requesting further information and/or registration, etc. In another scenario, an MCMS representative may be notified when a new marketing entity profile has been generated, and may manually obtain relevant information and/or contact the marketing entity regarding registration.

### Marketing Communication Link

An MCL may be any mechanism that enables a user to associate a marketing entity with his user profile, thereby subscribing the user to receive marketing communications from the marketing entity via MCMS 100. An MCL may be an electronic link or may be a physical link useable and/or readable by an electronic device. As depicted in FIG. 1, Web site publisher system 114 may maintain one or more data elements needed to display MCL 116 on a Web page or similar display mechanism and/or an MCL may include computer code or other necessary data to enable its functionality. For example, MCL 116 may be a graphical button that may be displayed on a Web page, in electronic ad, on a mobile display, etc. that may be selected by a user. Some examples of MCL 114 may be a Uniform Resource Locator (URL), a social network link (e.g., a Facebook “Like” icon, a Google+“+1” icon, a Twitter “follow” icon), etc.

Also depicted in FIG. 1, MCL 126 may be included on physical object 124, which may be, for example, a poster, a product, a magazine advertisement, a billboard, etc., and a user may interact with MCL 126 via user mechanism 106. For example, MCL 126 may be a Quick Response (QR) code or a barcode that a user may input into a smartphone. Some examples of MCL 126 may be a printed Web address, a data matrix code (e.g., a QR code, two-dimensional code, etc.), a product code (e.g., a Universal Product Code, a Stock-Keeping Unit code, etc.), a barcode, a Near Field Communication (NFC) medium (e.g., radio-frequency identification (RFID) code, etc.), etc.

In one scenario, an MCL may be coded to enable MCMS 100 to add a marketing entity to marketing entity registry 226 after the MCL has been selected. In one example embodiment, the MCL may interact with an API to enable its functionality. Once selected, the MCL may enable the communication of all necessary registration information to MCMS 100, such as the name of an associated marketing entity, an email address, a Web site address, social network account data (e.g., Facebook profile link, Twitter profile link, etc.), an encryption key, etc. Alphanumeric data, a URL, a tracking cookie, etc., may be communicated to MCMS 100 as well. Any such data may be employed as a marketing entity identifier.

Any mechanism that enables MCMS 100 to associate a marketing entity with a user profile may be considered an MCL, even if the mechanism itself is not inherently specific to marketing purposes. For example, the Twitter “Following” feature is not marketing specific, but can be used for marketing purposes and may be, therefore, may be considered an MCL. As another example, a UPC, while related to a product, may not be inherently marketing-specific, but MCMS 100 may employ the UPC to determine a related marketing entity and, therefore, it may be considered an MCL.

An MCL may be included in a marketing communication itself. For example, a social network post, text message, or marketing email may include an MCL. For example, a marketing email may provide an MCL as an alternative to an “unsubscribe” link. Alternatively, when a user clicks an unsubscribe link, user mechanism 106 may be directed to present an unsubscribing Web page which requests the user confirm his wish to unsubscribe and an MCL may be included on the Web page. The MCL may allow a user to shift the receipt of marketing communications to MCMS 100 instead of simply unsubscribing. As such, the marketing entity may be able to obtain a new avenue of reaching the user (i.e., MCMS 100) while the user opts out of another (i.e., unsubscribes from the marketing entity's mailing list).

In one embodiment, an MCL may be an account identifier, such as a financial account identifier (e.g., a credit card number, online payment identifier (e.g., account number, login credentials, etc.), checking or saving account number, etc.) or a loyalty account identifier (e.g., a loyalty account number, reward program number, etc.). When provides a user provides an account identifier to a merchant at a time of sale, such as at a point of sale in-store or at an online point of sale, MCMS 100 may receive information regarding the associated transaction and use the transaction information to associate the merchant, products, product manufacturers, purchase data, etc. with the user's user profile. As an account identifier may not be inherently associated with one marketing entity, it may serve as an MCL for multiple marketing entities. For example, as a user employ a credit card at multiple merchants and each merchant may be associated with the user's user profile or the user may employ a loyalty card while purchasing multiple products at a merchant and each product's manufacturer may be associated with the user profile. In one embodiment, when a user registers an account identifier, he may select whether or not the account identifier is to be treated as an MCL. A user may access his user profile to remove marketing entities that have been added via an account identifier MCL, block marketing entities to prevent them from being added via an account identifier MCL, etc.

### Subscribing to a Marketing Entity Via a Marketing Communication Link

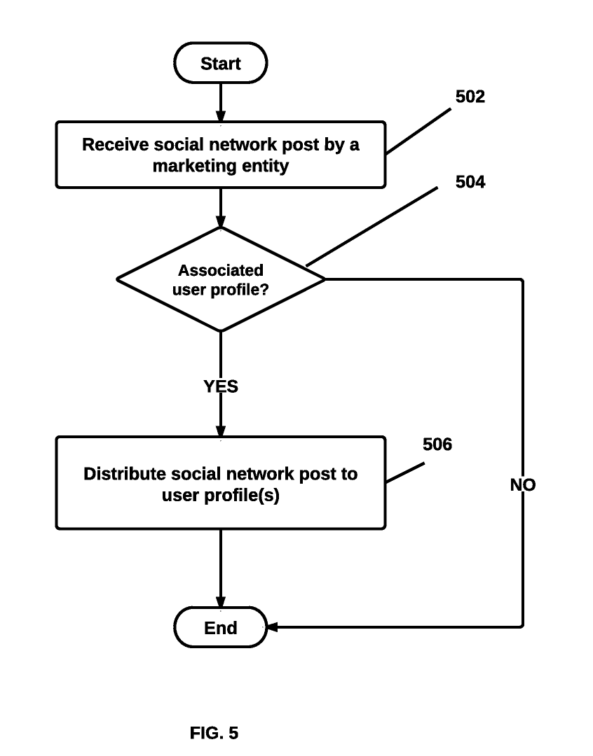

FIG. 4 depicts a flowchart of various steps in a method for associating a marketing entity with a user profile via a MCL according to an example embodiment. MCMS 100 may receive a marketing entity identifier once a user has selected an MCL (step 402). For example, a user employing a computer (e.g., user mechanism 106) may view MCL 116 on a Web page published via Web site publisher system 114 and may select MCL 116 to subscribe to the associated marketing entity's marketing communications. As another example, a user may view MCL 126 (e.g., a QR code or UPC) on a product and employ a smartphone (e.g., user mechanism 106) to scan it to indicate interest in a marketing entity associated with the product. As yet another example, a user may employ a financial account or loyalty account associated with his user profile while conducting a transaction. Once the MCL is selected, the marketing entity identifier indicated by the MCL may be communicated to MCMS 100 via electronic network 108.

Once MCMS 100 has received the marketing entity identifier, it may determine if the user has an MCMS user profile (step 404). A user may be prompted to provide credential data, such as a username and password. Alternatively, if a user has previously enrolled and/or signed into his user profile, credential data may be pre-stored on user mechanism 106 and this credential data may be accessed automatically by MCMS 100. For example, MCMS 100 may receive tracking cookie data from a Web browser included in user mechanism 106. As another example, MCMS 100 may receive credential data stored in a smartphone app included in user mechanism 106.

If the user has a user profile, MCMS 100 may access it (step 408). If the user does not have a user profile, MCMS 100 may generate a user profile (step 406) and then access the newly created user profile (step 408). MCMS 100 may initiate the user profile creation previously described or may enable a different user profile creation procedure. For example, MCMS 100 may only obtain user data necessary for use of MCMS 100, such as a credential data, and store the received user data in association with a new user profile.

Once MCMS 100 has accessed the user profile, it may analyze the received marketing entity identifier to determine whether MCMS 100 has a corresponding marketing entity profile within marketing entity registry 226 (step 410). If MCMS 100 does not have a corresponding marketing entity profile, it may generate one as previously described (step 412). MCMS 100 may store data associated with the marketing entity in association with the received marketing entity identifier or with a different marketing entity identifier (e.g., one more conducive to MCMS 100 use).

Once a marketing entity profile has been located or created, MCMS 100 may associate the marketing entity with the user profile (step 414). Associating a marketing entity with a user profile enables the user to receive marketing communications from the marketing entity, such as emails, social network posts, text messages, etc. MCMS 100 may determine one or more marketing communications the marketing entity distributes via MCMS 100 and enable the user to receive these communications.

As mentioned, an account identifier may serve as an MCL and, therefore, may be a source for associating a marketing entity with a user profile. The entity associated with an account identifier (e.g., a merchant, a financial institution (e.g., bank, credit card issuer, online payment provider, etc.), may communicate data to MCMS 100 to enable the association of a marketing entity. For example, a merchant system (e.g., marketing entity system 102) or financial institution system 128 may interact with MCMS 100 via an API. In another scenario, MCMS 100 may request data from such entities. For example, MCMS 100 may periodically poll financial institutions systems or merchant systems associated with user profiles to retrieve transactional data to identify data (e.g., via merchants, manufacturers, brands, products, etc.) to add to the relevant user profiles. In order to identify marketing entities, MCMS 100 may analyze name data included in transactional data, compare marketing entity identifiers included with transactional data with known marketing entity identifiers, etc.

In one embodiment, any marketing entity added to a user profile in an automatic fashion (e.g., via an account identifier) may not be active in the user profile until the user has accessed MCMS 100 and approved the marketing entity. For example, automatically added marketing entities may be shown as pending until a user may approves or declines their association with his user profile.

### Receiving Marketing Communications Via a Social Network

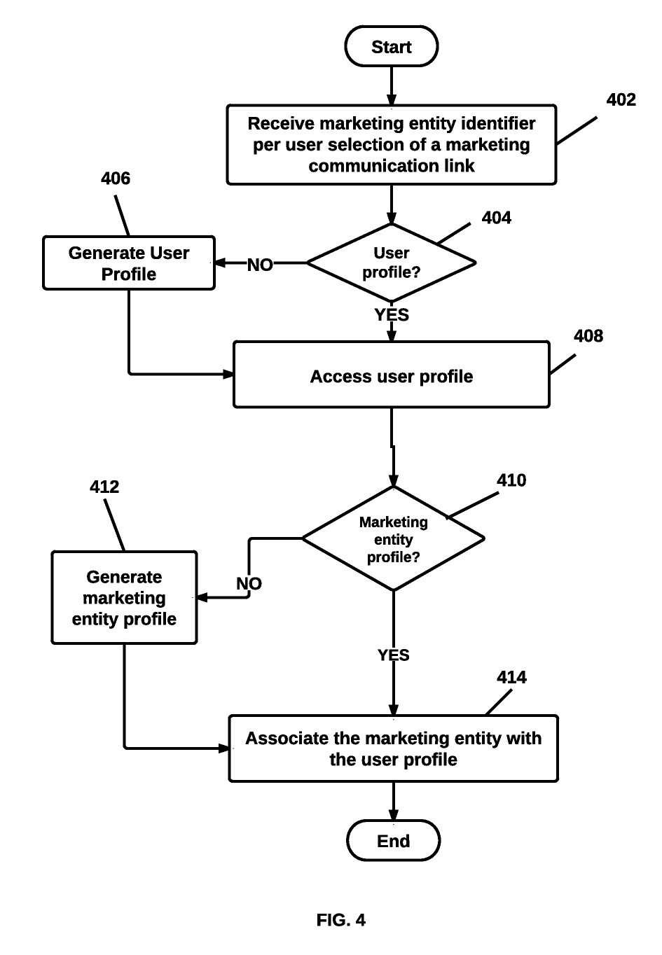

FIG. 5 depicts a flowchart of various steps in a method for managing the receipt of a social network post via MCMS 100 according to an example embodiment. MCMS 100 may receive social network post distributed by the marketing entity (step 502). MCMS 100 may be configured to obtain social network posts from any marketing entity included in marketing entity registry 226 for which it has social network account data. In one scenario, MCMS 100 may receive the social network post from a marketing entity's social network feed. For example, MCMS 100 may employ an API to access social network system 104 and obtain marketing communications posted by the marketing entity. Alternatively, or additionally, MCMS 100 may be configured to obtain social network posts in a fashion akin to a standard social network user, thereby serving as a proxy for its own users. For example, MCMS 100 may be configured to “Follow” a marketing entity on Twitter or may “Like” a marketing entity on Facebook, and thereby access the marketing entity's posts.

Once MCMS 100 has received a marketing communication, it may determine if a user profile is associated with the marketing entity (step 504). For example, MCMS 100 may determine if a user profile includes a marketing entity identifier corresponding to the related marketing entity. If not, MCMS 100 may ignore the social network post or it may store it. MCMS 100 may store undeliverable social network posts for data analysis, so that they may be delivered to a user that subsequently associates his user profile with the marketing entity, etc.

If the received social network post is from a marketing entity associated with a user profile (e.g., via a marketing entity identifier), MCMS 100 may distribute the social network post to the associated user profile(s) (step 506). MCMS 100 may notify the corresponding user of the received social network post via email, social network messaging, text message, instant messaging, etc., and the user may access his user profile to view it. Alternatively, or additionally, a user may be notified upon accessing his user profile.

### MCMS Email Address

MCMS 100 may receive and distribute marketing emails distributed by a marketing entity. In one example embodiment, a user may receive marketing emails via a specialized MCMS email address. MCMS 100 may employ one or more general MCMS email addresses to be provided to marketing entities by a user or by the MCMS service. For example, a general MCMS email address may include a multi-character codename (e.g., “marketing_{—}982392KSFVA14SF@MCMS.com”) and MCMS 100 (or an MCMS service representative) may provide the general MCMS email address to a marketing entity once it registered. A general MCMS email address may be designed to be not readily ascertainable by a user to prohibit a user from unsubscribing from the marketing entity directly (and, by doing so, possibly unsubscribing one or more users associated with the marketing entity). Furthermore, a general MCMS address may be designed so that when MCMS 100 receives an email addressed to the general MCMS address, it may reference the “To” address or header information against a set of registered marketing entity email addresses associated with the general MCMS address. This may enable MCMS 100 to verify that the entity sending an email to the general MCMS address is in fact an authorized marketing entity. When the marketing entity wishes to distribute a marketing email, it may send the marketing email to the general MCMS email address. MCMS 100 may then communicate the marketing email to users, as described herein.

Additionally, or alternatively, a user may be provided with an individual MCMS email address and this email address may be associated with the corresponding user profile. For example, a user's MCMS email address may be “bobsmith@MCMS.com.” When a user wishes to receive marketing emails from a marketing entity, he may provide the individual MCMS email address to the marketing entity and the marketing entity may employ the email address as it would a standard email address. MCMS 100 may receive emails sent to an individual MCMS email address in a same fashion similar to that of a traditional email system. As the individual MCMS email address is associated with a user profile, MCMS 100 may readily determine the user to which to distribute the marketing email. As the individual MCMS email address's purpose is to receive marketing emails and because MCMS 100 may screen received emails (see below), the user may feel comfortable distributing it readily.

In one example embodiment, a user may have more than one individual MCMS email address and an individual MCMS email address may be configured to assist with the organization of marketing emails. An individual MCMS email address may include data that indicates a folder in which to file a marketing communication, a tag to apply to a marketing communication, etc. and MCMS 100 may organize emails received via that email address accordingly. MCMS 100 may generate a categorized, individual MCMS email address for a user per a folder, tag, etc., the user establishes, a user may be allowed to configure a categorized, individual MCMS email address, etc. Upon receiving a marketing email via an individual MCMS email address, MCMS 100 may determine if the receiving individual MCMS email address includes organizational data. If not, the marketing email may be associated with a user's general MCMS inbox. If the individual email address is formatted to indicate organizational data, MCMS 100 may organize the marketing email accordingly. If the user profile corresponding to the individual MCMS email address does not have a category corresponding to the included data, MCMS 100 may generate the category and organize the marketing email (and subsequent marketing emails sent to that categorized, individual MCMS email address) accordingly. For example, an individual MCMS email address may be formatted as “username-category@MCMS.com” to enable organization and any email received via this email address may be organized (e.g., filed in a folder, tagged, etc.) per the “category” indicated in the email address. For example, all emails sent to “bobsmith-fishing@MCMS.com” may be automatically organized by MCMS 100 as “fishing” emails for the user.

### Receiving Marketing Communications Via an MCMS Email Address

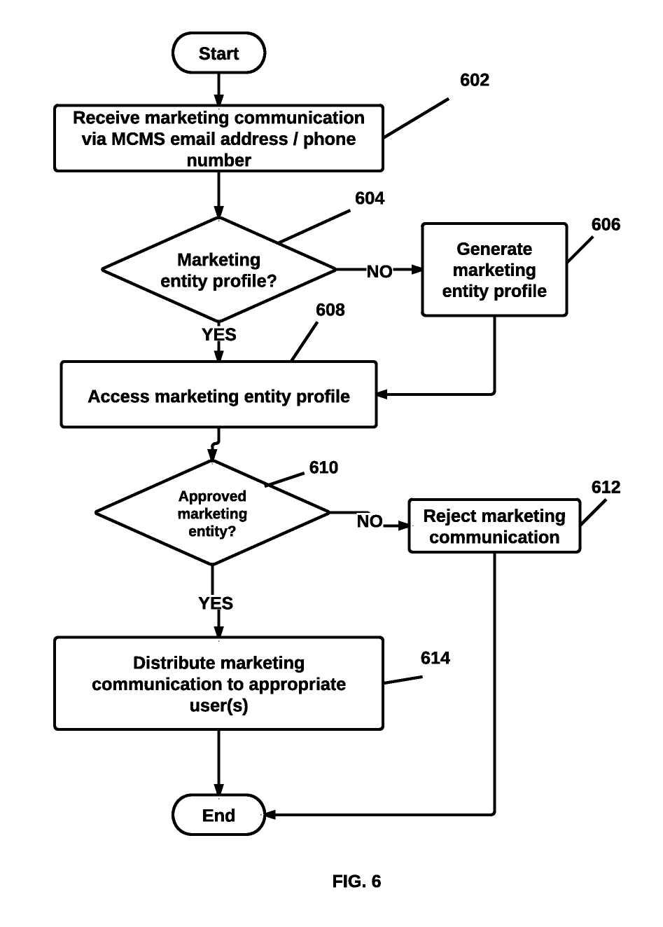

FIG. 6 depicts a flowchart of various steps in a method for managing the receipt of an email via a MCMS 100 according to an example embodiment. MCMS 100 may receive an email via an MCMS email address (step 602). As mentioned, the MCMS email address may be a general MCMS email address or may be a user's individual MCMS email address (including a categorized, individual MCMS email address).

MCMS 100 may analyze the received email to determine whether MCMS 100 has a corresponding marketing entity profile within marketing entity registry 226 (step 604). In one scenario, MCMS 100 may be function as a multi-channel “sender-aware” inbox, as MCMS 100 may enable a registry of senders. MCMS 100 may employ one or more data elements included with the email as marketing entity identifiers for this analysis. MCMS 100 may identify the marketing entity profile by a registered sender address (e.g., by referencing registered email addresses and/or domain names), a message header with an appropriate authentication key, or any other appropriate identification data. Because it is not uncommon for disparate marketing entities to employ the same service for distributing their marketing emails, MCMS 100 may examine various email features for identification purposes. A code, such as an authentication or encryption key (e.g., DKIM encryption), may be included in a header field, or participating marketing entities may use custom headers designed to enable identification by MCMS 100. For example, a marketing communication may include data that is readable by an API employed by MCMS 100.

If MCMS 100 does not contain a corresponding marketing entity profile, it may generate a new marketing entity profile as previously described (step 606). The new marketing entity profile may include data included within the email. Once MCMS 100 has accessed a marketing entity profile (step 608), it may determine whether the email is from an approved marketing entity (step 610). MCMS 100 may determine whether the email is an approved marketing entity by referencing one or more data elements included with the email against marketing entity registry 226. For example, in order to prevent fraudulent emails, MCMS 100 may confirm the email is actually from a registered marketing entity by determining whether the email includes an appropriate authentication key, or any other appropriate authentication method. In one scenario, MCMS 100 may send an email back to the sender's email address to confirm it was sent from a legitimate source. Marketing entity registry 226 may indicate approved marketing entities (e.g., a whitelist) and/or indicate unapproved marketing entities (e.g., a blacklist) and this information may be used to prevent unauthorized emails (e.g., spam, etc.) from reaching users. Because MCMS 100 may determine whether the marketing email is from an approved marketing entity, it may reduce or prevent a spam. If a general MCMS email address or an individual user's MCMS email address somehow is obtained to an outside party (e.g., a spammer), the aforementioned process may enable MCMS 100 to prevent an unauthorized email from reaching a user.

If MCMS 100 determines that the email is not from an approved marketing entity, the email may be rejected and not communicated to a user (step 612). In one example embodiment, if MCMS 100 rejects an email, it may notify an intended recipient and prompt the recipient to indicate whether the sender is legitimate. For example, MCMS 100 may send an email or text message to the user and/or may notify the user when he accesses his user profile. If the user indicates that the email is legitimate, MCMS 100 may provide the email to the user and may note the sender as approved for future marketing communications.

Once it has been determined that the email is from an approved marketing entity, the email may be distributed to the appropriate user(s) (step 614). If the email was sent to a general MCMS email address, the email is distributed to any user that has associated the sending marketing entity with his user profile. For example, the email may be distributed to any user profile associated with a corresponding marketing entity identifier. If the email was sent to a specific user's individual MCMS email address, the email is distributed to that particular user. If the individual MCMS email address includes categorization data, MCMS 100 may organize it accordingly.

In addition to using an individual MCMS email address to join marketing mailing lists, a user may employ it for other interactions with a marketing entity. For example, a user may provide his individual MCMS email address when placing an order with the marketing entity (e.g., an online merchant). One or more emails about the order, such as order confirmations, status updates, etc., may be received by MCMS and stored in association with the user profile. This may allow a user to group together all of a marketing entity's communications sent to him. For example, through MCMS 100, a user may receive marketing emails from Amazon.com as well as emails regarding orders the user placed with Amazon.com.

### MCMS Phone Number

MCMS 100 may receive and distribute marketing text messages distributed by a marketing entity. The process may function in manner similar to receiving a marketing email via MCMS 100, however instead of an MCMS email address, an MCMS phone number may be used. An MCMS phone number may not function as a phone number in a traditional sense (e.g., it may not be associated with a voice account), but it may serve as an avenue by which a user may receive marketing text messages. In alternate example embodiment, the MCMS phone number may be associated with a user's actual phone number or may be associated with a voice account. MCMS 100 may employ one or more general MCMS phone numbers to be provided to marketing entities by a user or by the MCMS service. When a marketing entity wishes to distribute a marketing text message, it may send the marketing text message to a general MCMS phone number and MCMS 100 may receive the marketing text message via this channel. MCMS 100 may then communicate the marketing text message to users. Additionally, or alternatively, a MCMS user may be provided with an individual MCMS phone number and this phone number may be associated with a corresponding user profile. As with an individual MCMS email address, an individual MCMS phone number may include organizational data to enable MCMS 100 to organize marketing communications received via the categorized, individual MCMS phone number. When a user wishes to receive marketing text messages from a marketing entity, he may provide the individual MCMS phone number to the marketing entity and the marketing text messages may be received by MCMS in a same fashion similar to that of text message system 120. As the MCMS phone number is associated with a user profile, MCMS 100 may readily determine the user to which to distribute the marketing email. As the individual MCMS phone number's purpose is to receive marketing text messages and because MCMS 100 may screen received text messages, the user may feel comfortable distributing it readily.

### Receiving Marketing Communications Via an MCMS Phone Number

FIG. 6 depicts a flowchart of various steps in a method for managing the receipt of a text message via a MCMS according to an example embodiment. MCMS 100 may handle the receipt of text messages via an MCMS phone number in a fashion similar to the manner in which it handles the receipt of email messages, as previously described. It is to be understood that while there may be one or more technical differences in the handling of text message versus an email communication, the logical processes employed by MCMS 100 are functionally similar and therefore the previous description of FIG. 6 in relation to email messages may be applied to text messaging as well.

### MCMS Email Extension

In one example embodiment, MCMS 100 may enable an email extension (e.g. a plug-in, extension, gadget, widget, add-on, software, etc.) for a Web email service, such as Yahoo Mail or Gmail, and/or an email client, such as Microsoft Outlook or Mozilla Thunderbird. For example, as depicted in FIG. 1, email accounts maintained by email system 110 may be enabled for MCMS 100 functionality via email extension 122. The email extension may provide additional information beyond what is conveyed in the received email. For example, based on the sender of the email and identification headers (e.g., DKIM, etc.), MCMS 100 may locate the corresponding marketing entity and provide profile information and other emails, posts, and other information from the sender to be rendered in the traditional inbox in conjunction with and/or augmenting the information otherwise rendered for the user.

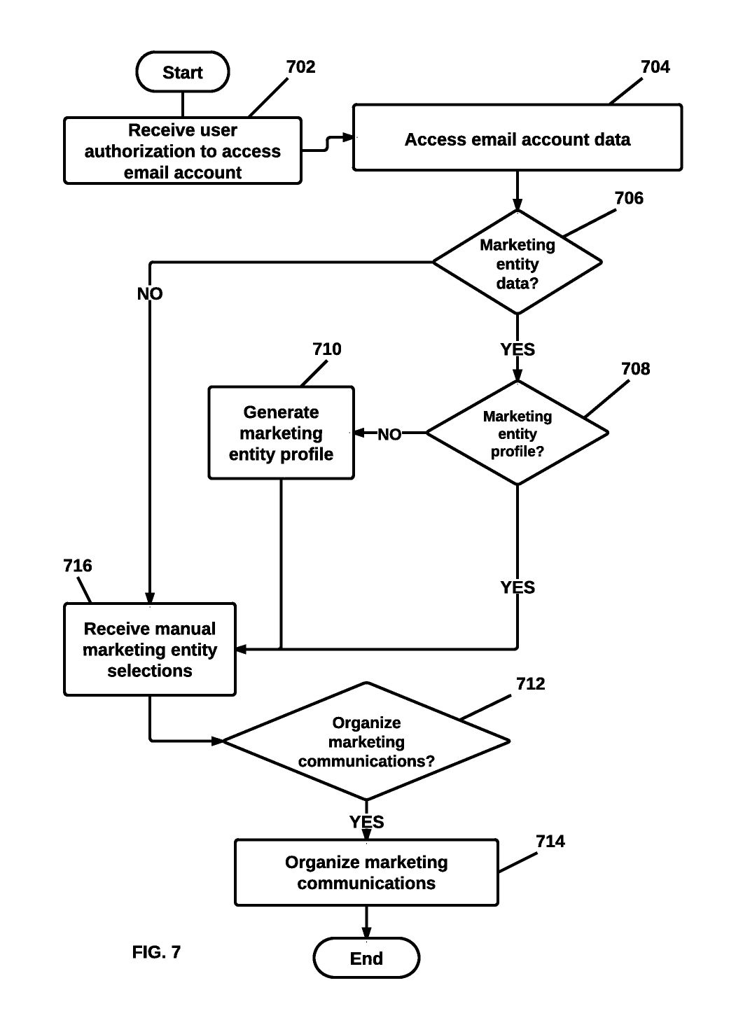

FIG. 7 depicts a flowchart of various steps in a method for managing the receipt of an email via email extension 122 according to an example embodiment. Although the description herein describes email extension 122 as performing various functions, it is to be understood that email extension 122 may be coded to perform these operations as a conduit for MCMS 100 rather than itself and/or may perform one or more operations in conjunction with MCMS 100. Once email extension 122 receives user authorization to access his email account (step 702), email extension 122 may access email account data (step 704) and may analyze the email account data to determine the presence of marketing entity data, such as marketing emails and marketing entity contacts (step 706). If email extension 122 determines that marketing entity data is not present in the email account data, it may prompt the user to select manually one or more marketing entities included in marketing entity registry 226 whose marketing communications the user would like to organize (step 716).

Email extension 122 may analyze email account data in a fashion similar to the manner in which MCMS 100 may do during user profile creation (see FIG. 3). If email extension 122 determines that marketing entity data is present, it may determine whether MCMS 100 has a marketing entity profile for the associated marketing entity (step 708). Email extension 122 may employ filtering methods to determine the presence of registered marketing emails, such as be examining email signature data, examining sender addresses, via authentication procedures (e.g., authentication and/or encryption keys), sending an authentication email to a sender to verify the sender, etc. In one example embodiment, email extension 122 may handle large quantities of email account data by employing one or more filtering procedures. For example, MCMS 100 may filter out emails sent from common email Web services, such as Gmail, Yahoo, and Hotmail, as these are not likely to have been sent from marketing entities. In one scenario, email extension 122 may interact with one or more servers to enable the processing of large amounts of email account data.

If the marketing entity data does not include registered marketing entities, email extension 122 may use the obtained marketing entity data to enable MCMS 100 to generate a marketing entity profile (step 710). Once email extension 122 has determined the presence of a corresponding marketing and/or generated a marketing profile, it may prompt the user to select manually one or more additional marketing entities included in marketing entity registry 226 whose marketing communications the user would like to organize (step 716).

Email extension 122 may determine whether to enable email extension 122 to organize corresponding marketing communications located in email account data and/or manually selected by the user (step 712). The user may be prompted to confirm which marketing entity communications he would like to have email extension 122 organize. Alternatively, a user may authorize email extension 122 organize marketing communications automatically.

Email extension 122 may then organize marketing communications it has located, as well be enabled to organize future marketing communications received via the email account (step 714). Once email extension 122 organize marketing communications by associating them with a specialized marketing folder and/or tag. Subsequent emails from a recognized and/or approved marketing entity may be routed to the marketing folder and/or marked with a marketing tag. If email system 110 does not enable an email communication to be in multiple folders or have multiple tags or if the user is employing another extension which limits the number of folders or tagging for emails, email extension 122 may duplicate the email in order to allow it to be in multiple folders or have multiple tags (e.g., an email may be in the marketing folder as well as an inbox folder). In one example embodiment, if MCMS 100 and/or email extension 122 is configured to enable email extension 122 to employ individual MCMS email addresses, email extension 122 may organize emails received via a categorized, individual MCMS email address according to the organizational data included in the categorized, individual MCMS email address. If email extension 122 creates a folder and/or tag for organization purposes (either automatically or per user instruction), email extension 122 and/or MCMS 100 may create a corresponding categorized, individual MCMS email address.

In one scenario, if email extension 122 recognizes a registered marketing entity via user's email account data, it may query the user to confirm whether he would like access to other marketing communications by that marketing entity. This may enable a user to stop receiving unwanted marketing communications. For example, if a user is receiving marketing emails from L.L. Bean and L. L. Bean is a registered marketing entity, email extension 122 may prompt the user to confirm whether he would like to continue to receive marketing communications from L. L. Bean.

As MCMS 100 may have access to marketing communications from an identified marketing entity other than email communications, email extension 122 may enable a user to access these other marketing communications via his email account. For example, email extension 122 may provide a user with access to a marketing entity's social network posts, user comments, incentives, etc., in addition to emails via his email account. This additional information may be presented in conjunction with a marketing email or may be separated into another logical area accessible via the email account. Additionally, email extension 122 may query the user to indicate whether he would like to access marketing communications that MCMS 100 has previously stored from a marketing entity.

In addition to, or instead of, accessing an email account to sort it, email extension 122 may enable MCMS 100 to create or enhance a user profile as described in relation to FIG. 3. Additionally, email extension 122 may enable a user to provide feedback to marketing entities, as described below.

### Marketing Communication Delivery

For any marketing communication type (e.g., social network post, marketing email, text message, etc.), MCMS 100 may be configured to receive marketing communications on a schedule set by a marketing entity, an MCMS service provider, a user, etc. and/or marketing communications may be received when they are distributed. For example, if a marketing entity makes a social network post, MCMS 100 may receive the social network post from the corresponding social network system 104 (e.g., Facebook, Twitter, etc.), if the marketing entity sends an email received by email system 110, email system 110 may communicate the email to MCMS 100, or if the marketing entity sends a text message via text message system 120, text message system 120 may communicate the text message to MCMS 100. In an alternate example embodiment, a marketing entity may issue a marketing communication via marketing entity system 102 to MCMS 100 directly, instead of, or in addition to, sending the marketing email via a third party system. Marketing entity system 102 may push marketing communications to MCMS 100 and/or MCMS 100 may pull marketing communications from MCMS 100. MCMS 100 may personalize a received marketing communication, thereby alleviating the need of the marketing entity to do so. For example, MCMS 100 may be configured to perform an intelligent search-and-replace, such as a mail-merge, to identify one or more fields in a marketing communication that are to be automatically populated by a set of predetermined information, such as the current date, etc. MCMS 100 may perform segmentation of the marketing communication delivery per instructions provided by a marketing entity, either embedded in the marketing communication or provided separately. Such instructions may specify that a marketing communication is to be distributed to specific users based on one or more characteristics of their user profile data. For example, a marketing entity may specify that a marketing communication only be distributed to men or only to women, or only to users who have purchased from a particular merchant before.

Marketing communications received by MCMS 100 may be delivered to users in one or more fashions. A user may be enabled to configure his user profile to specify the delivery format. A user may receive each type of communication separately or may opt to receive one or more marketing communication types in an augmented manner. For example, emails, social network posts, and text messages from one marketing entity may be compiled and presented together. In one scenario, MCMS 100 may analyze a received communication to determine whether it is specific to a user or a more general marketing communication and MCMS 100 may be configured to handle user-specific communications differently than general ones. For example, MCMS 100 may differentiate between generic newsletters and personalized communications. Furthermore, a user may be enabled to organize, customize, and manage the marketing communications he has received. For example, a user may categorize marketing entities, marketing communication types, marketing communication offers (e.g., coupons, limited time offers, etc.), etc. If a user is employing MCMS 100 for product ordering purchases, such as by using an individual MCMS email address when placing an order, MCMS 100 may assist a user by analyzing received order data. For example, a user may use data aggregation functions of MCMS 100 for expense tracking, budgeting, and other financial services.

MCMS 100 may expunge marketing communications after a particular time period. For example, marketing communications six months or older may be removed from user profiles. The rate at which a marketing entity's marketing communications are expunged may be based upon the frequency of a marketing entity's distribution. MCMS 100 may store marketing communications from a marketing entity that issues communication infrequently longer than one that issues marketing communications frequently. In one scenario, a user may determine how long one or more marketing communications are to be stored.

Marketing Communication with a Response Link

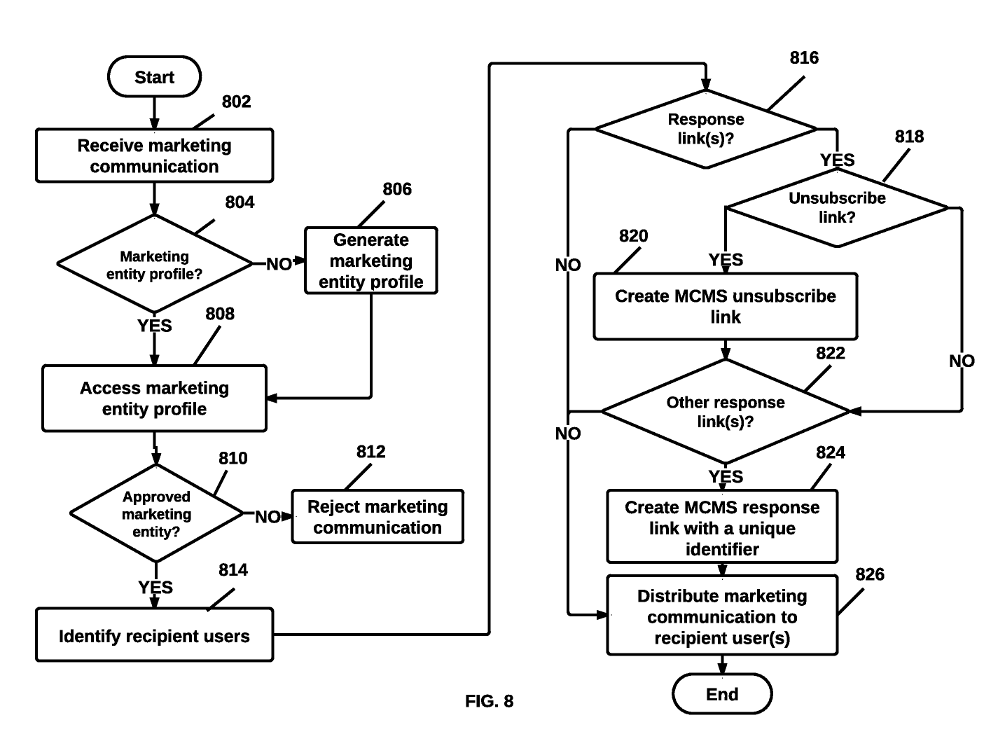

FIG. 8 depicts a flowchart of various steps in a method for delivering a marketing communication with a response link via MCMS 100 according to an example embodiment. MCMS 100 may enable the delivery and tracking of a marketing communication (email, text, post, ad, etc.) including a response link (e.g., a URL) without the marketing entity needing to personalize the marketing communication (including the link) with a personalized code (e.g., recipient identifier, email address, phone number, etc.). As described herein, MCMS 100 may alleviate the need of a marketing entity to distribute a personalized marketing communication to each recipient. Rather, the marketing entity may communicate a single instance of a marketing communication to MCMS 100, and MCMS 100 may in turn personalize the marketing communication for each of a set of multiple recipients. As MCMS 100 may customize an included response link, the marketing communication itself may serve as a generic template, thereby alleviating the need for the marketing entity to provide recipient-specific data. This configuration may greatly reduce the resources required to distribute a marketing communication (e.g., bandwidth, etc.). It is to be understood that the steps described herein may apply to any marketing communication type and, as such, MCMS 100 may distribute a marketing communication with a response link included in, for example, a social network post, an email communication, a text message, etc.

MCMS 100 may receive a marketing communication from a marketing entity (step 802) and may determine whether the marketing entity has a corresponding marketing entity profile within marketing entity registry 226 (step 804). If MCMS 100 does not contain a corresponding marketing entity profile, MCMS 100 may generate a new marketing entity profile (step 806). MCMS 100 may access the corresponding the marketing entity profile (i.e., a previously generated one or a newly generated profile) (step 808) and determine whether the marketing communication is from an approved marketing entity (step 810). If MCMS 100 determines that the marketing communication is not from an approved marketing entity, the marketing communication may be rejected (step 812).

MCMS 100 may identify the recipient users of the marketing communication (step 814). The marketing communication may include a listing of recipients (e.g., via the recipients' individual MCMS email addresses, etc.) or the marketing entity may have a pre-set recipient list maintained by MCMS 100 (e.g., MCMS 100 may identify which recipients have opted to receive marketing communications from the marketing entity). For example, MCMS 100 may determine which user profiles are associated with the marketing entity.

MCMS 100 may analyze the marketing communication to determine whether it includes one or more response links (step 816). A response link may be any link that enables a user to access further information via user mechanism 106, such as, for example, a URL. In one example embodiment, if the marketing communication includes a response link, MCMS 100 may determine whether the response link is an unsubscribe link (step 818). Typically, when selected, an unsubscribe link enables a user to be removed from a marketing entity's distribution list. If MCMS 100 determines the presence of an unsubscribe link, it may create an MCMS unsubscribe link, thereby replacing or altering the unsubscribe link (step 820). When selected by a user, an MCMS unsubscribe link may dissociate the corresponding marketing entity from the user's profile, thereby ensuring that the user does not receive further marketing communications from the marketing entity via MCMS 100 (unless, for example, the user resubscribes). In one example embodiment, MCMS 100 may not replace or alter an unsubscribe link and, as such, steps 818 through 822 may be omitted.

If MCMS 100 determines that the marketing communication includes one or more other response links (step 822), MCMS 100 may create an MCMS response link with a unique identifier (step 824). Alternatively, MCMS 100 may create an MCMS response link with a user identifier before or immediately prior to rendering the marketing communication to the user. To create an MCMS response link, MCMS 100 may add a unique identifier to the existing response link or may create a new response link that includes the unique identifier. A unique identifier may include data (e.g., alphanumeric data) that identifies a specific user and/or associates the response link with a particular user profile, thereby personalizing the MCMS response link to the user. The unique identifier may be generated in one or more fashions.

The user identifier may be an existing identifier or may be generated by MCMS 100. In one example embodiment, one or more unique identifiers may be associated with a specific recipient so that a unique identifier may be used repeatedly to identify a particular user. Alternatively, a unique identifier may be assigned for each marketing communication. In one example embodiment, a user's unique identifier may be only be unique in regard to a particular marketing communication so that the unique identifier enables the marketing entity only to track the recipient's interaction with a particular marketing communication, but not other marketing communications. Because a recipient's unique identifier is not associated with other marketing communications, the marketing entity may not be able to associate the recipient with multiple marketing communications, thereby protecting the recipient's anonymity.

In one example embodiment, a unique identifier is generated per a rule specified in the marketing entity's profile or per marketing entity data accessible by MCMS 100 (e.g., data maintained by marketing entity system 102). In another example embodiment, a unique identifier may be generated randomly by MCMS 100 and recorded within data store 200. In another example embodiment, a unique identifier may be generated based upon recipient data known by the marketing entity so that the marketing entity may identify the recipient when the MCMS response link is selected. For example, marketing entity system 102 may reference the unique identifier against its records of intended recipients. In another example embodiment, marketing entity system 102 may interact with MCMS 100 (e.g., via an API) to verify the authenticity of the MCMS response link and/or user identifier, to further identify the recipient (e.g. access user data maintained by MCMS 100), identify the MCMS response link (e.g., to mark the link as used so that it may not be reused), etc. Per a user's preferences, marketing entity system 102 may be able to access one or more details regarding the user. In one example embodiment, marketing entity system 102 may not access data that identifies a user in a personally identifiable way, but rather may access more generalized data. For example, it may be demographic data indicating a user's sex, geographic location, age, etc., but not the user's actual name, address, etc.

MCMS 100 may distribute the marketing communication to each recipient user (step 826). When a user views the marketing communication and selects an included MCMS response link (e.g., clicking it, selecting it via a gesture, etc.), user mechanism 106 may respond accordingly. By tracking user identifiers, MCMS 100 and/or marketing entity system 102 may limit the number of users who have access to an offer associated with a response link (e.g., the first 500 users), to limit the number of views to the information associated with a response link, etc.

In one example embodiment, email system 110, social network system 104, and/or text message system 120 may interact with MCMS 100 in order to use the aforementioned MCMS response link functionality. For example, email systems 110 such as Yahoo Mail, Google Gmail, Microsoft Hotmail, other enterprise mail handlers and/or providers may interact with MCMS 100 via an API in order to accomplish one or more of such functions. It is to be understood that any of the aforementioned MCMS response link functions may be accomplished by email system 110, social network system 104, and/or text message system 120 in addition to, or instead of, MCMS 100. For example, this methodology may be beneficial to email system providers as it may greatly reduce necessary storage requirements. For example, it is estimated that this configuration may reduce storage requirements by a factor of 100,000 to 2 million times depending on the number of recipients who are on a particular shared platform.

### User MCMS Interaction

MCMS 100 include a user interface mechanism 208 which may enable a user to interact with his user profile, interact with a marketing entity, share received marketing communications with other MCMS users and/or with individuals, provide feedback, configure preferences, etc. User interface mechanism 208 may enable a user to access his user profile and/or MCMS functions via one or more locations, such as via an MCMS Web site, via social network account, via an email account (e.g., via an MCMS email extension), via a smartphone app, etc. Additionally, email interface 122 may enable the receipt of user feedback and it is to be understood that the user interaction procedures described herein may be accomplished via email interface 122.

When a user receives a marketing communication via MCMS 100, he may be able to indicate whether he likes the marketing communication and/or the degree to which he likes it. MCMS 100 may enable a feedback interface to enable this. For example, a user may select a “thumbs up” icon if he likes a marketing communication or may select a “thumbs down” icon if he does not. As another example, the feedback interface may allow a user to rate a marketing communication, such as on a scale from one to five. Users may be enabled to provide a comment regarding a marketing communication, such as through an open message field and/or through survey-type interface. In one scenario, users' rankings and/or comments about a particular marketing communication may be shared with one another in addition to marketing entities. For example, when a user views a marketing communication, he may view the rankings and/or comments other users have provided for the same marketing communication or for the marketing entity in general.

In one example embodiment, MCMS 100 may enable a user to provide feedback for a marketing entity not registered with the system. For example, if MCMS 100 receives a marketing communication from an unregistered and/or unapproved marketing entity, it may prompt a user for feedback. This may be useful in case the marketing entity is later added or may assist in the determination of MCMS 100 whether to add the marketing entity to marketing entity registry 226. For example, user feedback and/or the marketing communication from an unregistered marketing entity may be stored in association with one or more data elements acquired from the marketing communication (e.g., date and time, one or more email attributes, headers, keys in the body context, etc.). These data elements may enable MCMS 100 to detect if it receives the unregistered and/or unapproved marketing communication again and may MCMS 100 store more user feedback in association with it. If such a marketing entity registers and/or becomes approved, MCMS 100 may grant the marketing entity access to the stored feedback data for the previously received marketing communication. Additionally, or alternatively, MCMS 100 may employ the feedback to determine the legitimacy of the marketing communication and, in turn, the associated marketing entity. For example, if users have provided negative feedback for the marketing entity and/or its communications, it may be prohibited from registration.

MCMS 100 may store user feedback data and, as described below, may make it accessible to marketing entities so that the marketing entities may analyze the user feedback data in order to determine the effectiveness of their marketing communications.

### Marketing Entity MCMS Interaction

MCMS 100 may include marketing entity interface mechanism 230 which may enable a marketing entity to access marketing entity profile, establish MCMS settings, view data regarding its marketing entity communications, analyze data, generate data reports, issue MCMS-specific marketing communications to users (e.g., incentives, games, contests, etc.), etc. For example, marketing entity interface mechanism 230 may enable a marketing entity to access a “dashboard” feature to perform such operations. Data that is made accessible to a marketing entity may be anonymous data that does not include references to particular users. The amount of a particular user's data made available to marketing entities may be set by the user and may vary for particular marketing entities. Conversely, users may be enabled to readily determine which marketing entities have access to their data and which kind of data. This configuration may enable both users and marketing entities to have perspective about how their data is employed and accessed and may this configuration may provide transparency between both user and marketing entities. For example, a user may reap the benefits of receiving a marketing communication and the marketing entity may obtain the benefits of having the marketing communication delivered (e.g., the user makes a purchase), but the user's privacy may be protected as user-specific data is kept secure and not shared.

A marketing entity may access MCMS 100 to analyze feedback data regarding a marketing communication. Feedback data may include data regarding how users ranked a marketing communication, how many users received and/or viewed a marketing communication, how many times a marketing communication was shared, etc. For example, a marketing entity may be able to determine that 25% of users liked a particular marketing communication. The marketing entity may view any user comments regarding the marketing communication and/or the marketing entity. As aforementioned, MCMS 100 may store feedback for unregistered and/or unapproved marketing entities. If such a marketing entity registers and/or becomes approved, it may access the data stored in association with the marketing entity's received marketing communications.

Furthermore, a marketing entity may have access to several levels of relationship data 206 between users, marketing entities, and marketing entity communications. For example, a marketing entity may analyze how many user profiles that subscribe to the marketing entity also subscribe to another marketing entity, how many users that like one marketing communication disliked another marketing communication, how many times a marketing communication was shared, etc. This type of analysis may enable a marketing entity to ascertain patterns or tendencies that may assist in the refinement of its marketing communications. Relationship data 206 may indicate relationships between users, marketing entities, and products. For example, a marketing entity may determine the percentage of users that like a particular merchant a particular product or brand. For example, 30% of the users who like Whole Foods may like 40% of a particular set of brands. Such analysis allows a marketing entity to identify relationships, or the lack thereof, and may enable the marketing entity to determine what user have in common or do not have in common. The marketing entity may be able to refine such analysis by adding more and more levels, thereby finding a more specialized group of users, marketing entities, or products. Relationship data 206 may be based upon particular marketing communications, marketing communications types, etc. For example, a marketing entity may determine not simply who bought a product, but which people who liked or received a marketing communication also bought the advertised product. This may provide insight into the path a user took to purchase a particular product.

A marketing entity may employ marketing entity interface mechanism 230 to distribute custom marketing communications. A marketing entity may distribute messages to marketing entity users who have associated the marketing entity with their account (and granted the marketing entity permission to communicate with them). In one scenario, a marketing entity may distribute custom marketing communications to users deemed as preferred users, such as users that have provided the marketing entity with their individual MCMS email addresses, with a certain quantity of user feedback, etc. Custom marketing communications may include incentives available to MCMS users, requests for feedback (e.g., “Which promotions did you like?”, “Which should we discount next month?” etc.) contest information, and, in general, such communications may enable the marketing entity to interact with users. In one example embodiment, based upon user permissions, a marketing entity may be able to interact with users that have not included the entity in their user profiles. For example, a marketing entity may offer such users an incentive to encourage them to subscribe to the marketing entity's communications. In one scenario, users may initiate communication with a marketing entity, such as to ask questions about products offered, about a particular promotion, etc.

In one example embodiment, MCMS 100 may notify a marketing entity whenever a user associates the marketing entity with his user profile. This may enable the marketing entity to update its records, note which users have switched from traditional marketing communication delivery processes to MCMS 100 processes, etc. For example, a marketing entity may ascertain when a user changes his mailing list email address to an MCMS email address or when a user opts to use MCMS 100 to receive mailing list communications rather than unsubscribe from the mailing list.

As mentioned, marketing entity system 102 may interact directly with MCMS 100. In one scenario, MCMS 100 may enable a marketing entity to access its analytical feature via its own software or third party software. For example, marketing interface mechanism 228 may include a platform that enables software plug-ins and marketing entity system 102 may access data stored at MCMS 100 via a software plug-in.

### MCMS Incentives

MCMS 100 may enable one or more an incentive programs to enhance user participation. A user may be rewarded for receiving and/or viewing marketing communications from a marketing entity via MCMS 100. Each time a user receives/views a marketing communication, he may be credited with an incentive value. In one scenario, the incentive value is a reward point. A user may be able to redeem accumulated reward points for rewards, such as products offered by participating marketing entities, or a reward point may have a monetary value with a particular marketing entity and a user may use the rewards towards the purchase price of a product. In another example embodiment, an incentive value may be a reward in of itself, such as value redeemable for a product associated with a marketing entity. In such an example embodiment, each marketing communication may not be associated with an incentive value, but rather an incentive value may be associated with a randomly determined marketing communication, much like a lottery drawing. In another scenario, an incentive value may be issued to a user who has demonstrated loyalty to the marketing entity, such as by subscribing to the marketing entity's communication for certain period of time, for having received a certain quantity of marketing communications, having purchased a particular product or dollar value worth of products, etc.

A user may be required to agree to one or more conditions in order to participate in the incentive program. For example, a user may be required to share one or more elements of data with a marketing entity in order to participate, thereby enabling the marketing entity to use the user's data in its data analysis.

MCMS 100 may manage multiple incentive programs and an incentive program may be configured by an MCMS service provider or one or more marketing entities. A marketing entity may use marketing entity interface mechanism 230 to setup an incentive program, for example, establishing incentive program rules and requirements, establishing an incentive directory listing, establishing an incentive value exchange rate (e.g., 100 rewards points earns a user $1.00 with of reward value, etc.), etc. A marketing entity may limit an incentive program to a particular form of marketing communication in order to increase usage of that marketing communication type (e.g., email communications, social network posts, text messages, etc.). Alternatively, an incentive may be associated with multiple marketing communication types.

In one example embodiment, an incentive program may include the distribution of a vouchers and/or promotional codes that may be used for products associated with marketing entities. A voucher and/or promotional codes may be printable and redeemable at an offline merchant and/or may be used with online entities.

In another example embodiment, an incentive program may enable a user to receive preferential treatment. For example, an incentive program may be a VIP program. Additionally, or alternatively, an MCMS incentive program may be incorporated into a marketing entity's existing reward program. For example, a user may receive airline miles for receiving a marketing entity's communications. In another scenario, a received incentive value may be exchanged into a third party reward currency. For example, a user may convert an incentive value received from MCMS 100 into airline miles. The conversion may involve an exchange rate. For example, 1000 MCMS points may equal 100 AMEX points. MCMS 100 may be configured to integrate with the third party reward system to enable deduction of MCMS points and the crediting of third party incentive points. MCMS 100 and/or the third party may issue a statement detailing how the rewards were credited and/or debited.

In one example embodiment, the incentive value earned may be based upon the amount and/or quality of a user's participation with the incentive program. For example, while a user may accrue an incentive value by simply receiving marketing communications, he may obtain a greater value by performing other interactions with the marketing entity, such as by completing quizzes, participating in contests, providing feedback, etc. A user may earn an incentive value by providing feedback regarding a marketing communication. A user may not need to view the marketing communication, but may provide feedback indicating whether the marketing communication appears to be useful or not. MCMS 100 may present an incentive program report to a user and the report may indicate the quantity of incentive value earned and the amount not earned due to lack of interaction. In one scenario, the user may ascertain how his participation and incentive value earned compares to other users.

In one example embodiment, an entity associated with MCMS 100, such as an MCMS service provider, a marketing entity, or a user, may be enabled to receive an affiliate reward. When a user accesses a marketing communication via MCMS 100, it may include a link, such as a URL, associated with a marketing entity. For example, selecting the link may open up a marketing entity's Web page, a marketing entity incentive, etc. When the user selects the link, MCMS 100 may determine an affiliate code associated with the relevant marketing entity and add an affiliate code to the link (e.g., to the URL) so that marketing entity system 102 may determine how the user accessed the link (i.e., namely, via MCMS 100). If MCMS 100 does not have an affiliate code associated with the relevant marketing entity, it may reference other marketing entities until an appropriate code is found. For example, if MCMS 100 cannot locate an affiliate code for a particular brand, it may determine if there is an affiliate code for an appropriate parent marketing entity. The affiliate code may indicate which entity is to receive an affiliate reward (e.g., the MCMS service provider, a marketing entity, a user, etc.). For example, this procedure may enable an MCMS service provider to receive affiliate rewards for referring users to a marketing entity via MCMS 100.

### MCMS Mobile Marketing Communications

In one example embodiment, mobile marketing mechanism 234 may enable mobile marketing communications. MCMS 100 may enhance localized mobile incentive delivery by selecting incentives from marketing entities associated with a user's profile rather than, for example, random entities that are in proximity to the user. If a user has enabled a mobile user mechanism 106, such as a smartphone, with an MCMS app or other similar mobile functionality, mobile marketing mechanism 234 may enable the determination of the user's location via global positioning system (GPS) processes, triangulation, or any other appropriate locating procedure. Mobile marketing mechanism 234 may determine whether marketing entities have distributed marketing communications relevant to the user's location and present them via user mechanism 106. In one scenario, a user may receive only mobile marketing communications for those marketing entities with which he has subscribed. Alternatively, a user may configure his user profile preferences to indicate he wishes to receive location-based marketing communications regardless of whether he has subscribed to the associated marketing entity. A user may desire this configuration because he may wish to learn about marketing communications relevant to his surroundings regardless of the source. A user may define preferences that mobile marketing mechanism 234 may employ to determine which mobile marketing communications he wishes to receive, whether they are from marketing entity he has subscribed to or not. For example, a user may configure his user profile so that MCMS 100 may present marketing communications for coffee shops near his location, regardless of whether he has subscribed to the marketing entity or only from his subscribed marketing entities. As with other marketing communications, a user may provide feedback on the mobile marketing communications received, such as by indicating the mobile marketing communications he liked receiving, those he did not, preferred products or merchants of interest, etc.

Mobile marketing communications may be a feature handled directly by MCMS 100 or MCMS 100 may interact with third-party services to enable such localized marketing communications. MCMS 100 may aggregate distributed, localized marketing communications and employ them for its own procedures. If multiple sources provide the same marketing communication or if multiple marketing communications include the same offer, MCMS 100 may aggregate them, thereby eliminating or reducing the possibility of a user receiving the same marketing communication or offer from multiple sources.

### Marketing Entity Registry Directory

As aforementioned, MCMS 100 may maintain marketing entity registry 226 and, as a marketing entity may be a merchant, marketing entity registry 226 may serve as directory of participating organizations. A marketing entity may configure which data is available in its public profile. Users may employ marketing entity registry 226 as they may a merchant directory, such as the Yellow Pages, and search for marketing entities of interest. Not only may users search for marketing entities, but they may search for products offered by marketing entities. For example, a user may search for a grocery store or may search for Coca-Cola.

In one example embodiment, a user may search for local marketing entities. If MCMS 100 is enabled to determine a user's location, it may provide localized search results data and present marketing entities in proximity to the user's location. Additionally, or alternatively, a user may search for marketing entities that do not have a physical location or have a physical location not commonly accessible by the public. For example, a user may search for online retailers, such as Amazon, or for charities, such as the United Way or the Red Cross. A user may make a purchase or make a denotation by accessing the marketing entity via MCMS 100.

### Electronic Marketing Storage

In one example embodiment, MCMS 100 may be configured to interact with or include an electronic advertisement storage and searching system, such as the ones described in U.S. patent application Ser. No. 12/764, 906, filed Apr. 21, 2010, entitled “System and Method for Improving e-Commerce” and/or U.S. patent application Ser. No. 12/952,111, filed Nov. 22, 2010, entitled “System and Method for Improving E-Commerce with On-Demand Advertising.” Each of these applications and any applications claiming priority to them are incorporated by reference herein, in entirety, for all purposes.

According to example embodiments of the present invention, components of marketing network 118 including MCMS 100, marketing entity system 102, social network system 104, user mechanism 106, Web site publisher system 114, physical object 124, authentication service 112, email system 110, and text message system 120 may be implemented by various means. Means for implementing the systems, mechanisms and modules may include hardware, alone or under direction of one or more computer program code instructions, program instructions or executable computer-readable program code instructions from a computer-readable storage medium.

In one example, one or more apparatuses may be provided that are configured to function as or otherwise implement the systems, mechanisms and modules shown and described herein. Generally, an apparatus of exemplary example embodiments of the present invention may comprise, include or be embodied in one or more fixed or portable computing devices, a number of examples of which are provided above. The apparatus may include one or more of each of a number of components such as, for example, a processor connected to memory.

The processor is generally any piece of hardware that is capable of processing information such as, for example, data, computer-readable program code, instructions, etc. (generally “computer programs,” e.g., software, firmware, etc.), and/or other suitable electronic information. More particularly, for example, the processor may be configured to execute computer programs, which may be stored onboard the processor or otherwise stored in the memory. The processor may be a number of processors, a multi-processor core or some other type of processor, depending on the particular implementation. In another example, the processor may be embodied as or otherwise include one or more application-specific integrated circuits (ASICs), field-programmable gate arrays (FPGAs), etc. Thus, although the processor may be capable of executing a computer program to perform one or more functions, the processor of various examples may be capable of performing one or more functions without the aid of a computer program.

The memory is generally any piece of hardware that is capable of storing information such as, for example, data, computer programs and/or other suitable information. The memory may include volatile memory and/or non-volatile memory, and may be fixed or removable. Examples of suitable memory include random access memory (RAM), read-only memory (ROM), a hard drive, a flash memory, a thumb drive, an optical disk, a magnetic tape or some combination of the above. In various instances, the memory may be referred to as a computer-readable storage medium which, as a non-transitory device capable of storing information, may be distinguishable from computer-readable transmission media such as electronic transitory signals capable of carrying information from one location to another. Computer-readable medium as described herein may generally refer to a computer-readable storage medium or computer-readable transmission medium.

In addition to the memory, the processor may be connected to one or more interfaces for displaying, transmitting and/or receiving information. The interfaces may include a communications interface and/or one or more user interfaces. The communications interface may be configured to transmit and/or receive information, such as to and/or from other apparatus(es), network(s), etc. The communications interface may be configured to transmit and/or receive information by physical (wireline) and/or wireless communications links.

The user interfaces may include a display and/or one or more user input interfaces. The display may be configured to present or otherwise display information to a user, suitable examples of which include a liquid crystal display (LCD), light-emitting diode display (LED), plasma display panel (PDP), etc. The user input interfaces may be wireline or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), etc. The user interfaces may further include one or more interfaces for communicating with peripherals such as printers, scanners, etc.

As indicated above, program code instructions may be stored in memory, and executed by a processor, to implement functions of the systems, mechanisms and modules described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may be stored in a computer-readable storage medium that can direct a computer, a processor or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processor or other programmable apparatus to configure the computer, processor or other programmable apparatus to execute operations to be performed on or by the computer, processor or other programmable apparatus.

Execution of the program code instructions may produce a computer-implemented process such that the instructions executed by the computer, processor or other programmable apparatus provide operations for implementing functions described herein. Execution of instructions by a processor, or storage of instructions in a computer-readable storage medium, supports combinations of operations for performing the specified functions. It will also be understood that one or more functions, and combinations of functions, may be implemented by special purpose hardware-based computer systems and/or processors which perform the specified functions, or combinations of special purpose hardware and program code instructions.

These and other aspects of the present invention will become apparent to those skilled in the art by a review of the preceding detailed description. Although a number of salient features of the present invention have been described above, the invention is capable of other example embodiments and of being practiced and carried out in various ways that would be apparent to one of ordinary skill in the art after reading the disclosed invention. Therefore, the description should not be considered to be exclusive of these other example embodiments. Also, it is to be understood that the phraseology and terminology employed herein are for the purposes of description and should not be regarded as limiting.

1. A system for the aggregation and distribution of marketing communications, the system comprising:
a computer having computer-readable media comprising instructions that cause the computer to:
maintain a marketing entity registry containing one or more marketing entities from which the computer is configured to receive a plurality of types of marketing communications;
maintain a user profile specifying one or more marketing entities from which a corresponding user has elected to receive marketing communications;
aggregate one or more types of marketing communications distributed by the one or more marketing entities;
associate the one or more aggregated marketing communications distributed by the one or more marketing entities with the user profile, an aggregated marketing communication being associated with the user profile if the corresponding user has elected to receive marketing communications from the corresponding marketing entity; and
enable the user to access the one or more aggregated marketing communications, whereby the user is able to access a plurality of types of marketing communications via one application.

2. The system of claim 1, wherein a type of marketing communication is an email, a social network post, a text message, an electronic advertisement, or electronic marketing data associated with a physical object.

3. The system of claim 1, wherein the computer-readable media comprise instructions that further cause the computer to maintain one or more marketing entity profiles referenced by the marketing entity registry.

4. The system of claim 1, wherein the computer-readable media comprise instructions that further cause the computer to add a marketing entity to the marketing entity registry per one or more of a user instruction, via a marketing communication link, per third party account data registration, per marketing entity email address registration, and per marketing entity phone number registration.

5. The system of claim 4, wherein a marketing communication link initiates transmission of marketing entity registration information to the computer.

6. The system of claim 1, wherein the user profile is associated with a user identifier and the computer-readable media comprise instructions that further cause the computer to communicate a notification of one or more aggregated marketing communications based upon the user identifier.

7. The system of claim 6, wherein the computer-readable media comprise instructions that further cause the computer to organize one or more aggregated marketing communications associated with the user profile per a user preference.

8. A method for subscribing to a marketing entity's marketing communications via a marketing communication management system, the method comprising:
receiving, by a marketing communication management computer from a user, an instruction to associate a marketing entity identifier with a user profile, the marketing entity identifier being communicated to the marketing communication management computer per the user selecting a marketing communication link via a user mechanism,
accessing a user profile associated with the user;
determining whether the received marketing entity identifier is associated with a marketing entity profile and if the received marketing entity identifier is not associated with a marketing entity profile the marketing communication management computer generates a marketing entity profile associated with the received marketing entity identifier; and
associating the marketing entity identifier with the user profile to enable the user to receive one or more marketing communications from the marketing entity via the marketing communication management computer.

9. The method of claim 8, further comprising determining whether a user profile is associated with the user and if the user is not associated with a user profile the marketing communication management computer generates a user profile associated with the user.

10. The method of claim 8, wherein the marketing communication link is an electronic link or physical link useable or readable by an electronic device.

11. The method of claim 8, wherein the marketing communication is an email, a social network post, a text message, an electronic advertisement, or electronic marketing data associated with a physical object.

12. The method of claim 8, wherein the marketing communication link is included in a marketing communication.

13. The method of claim 8, wherein the marketing communication link is displayed on a Web page.

14. The method of claim 8, wherein the marketing communication link is a social network link.

15. A method for delivering a marketing communication via a marketing communication management system, the method comprising:
receiving, by a marketing communication management computer from a marketing entity, a marketing communication, the marketing communication management computer being configured to receive a plurality of types of marketing communications,
identifying one or more user profiles associated with the marketing entity,
distributing the marketing communication to one or more user profiles associated with the marketing entity, thereby enabling a user associated with a user profile to access the marketing communication via the marketing communication management computer.

16. The method of claim 15, wherein the marketing communication is an email.

17. The method of claim 16, wherein identifying one or more user profiles associated with the marketing entity comprises identifying one or more user profiles associated with an email address to which the marketing communication was distributed.

18. The method of claim 15, wherein the marketing communication a social network post.

19. The method of claim 18, wherein identifying one or more user profiles associated with the marketing entity comprises identifying one or more user profiles associated with social network account data corresponding to the marketing entity.

20. The method of claim 16, further comprising the marketing communication management computer organizing the marketing communication per a user preference indicated by a user profile.
